(19) United States
(12) Patent Application Publication
(10) Pub. No.: US 2010/0095237 A1
(43) Pub. Date: Apr. 15, 2010

(54) METHOD AND SYSTEM FOR DISPLAYING ONE OR MORE COMMERCIAL CONTENT TO A USER WITHIN A WINDOW DISPLAYING AN EMAIL CONTENT

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/519,874

(22) PCT Filed: May 26, 2008
(86) PCT No.: PCT/IN2008/000330

§ 371 Date: Jun. 18, 2009

(30) Foreign Application Priority Data
May 25, 2007 (IN) 986/MUM/2007

(51) Int. Cl. G06F 3/048; G06F 15/16

(52) U.S. Cl. 715/781; 709/206

(57) ABSTRACT

The present invention relates to a system and method for displaying one or more commercial content to a user within a window displaying an email content. The method comprises retrieving the one or more commercial content from an ad server. A notification is received when a user performs a user action to view the email content. In one embodiment, the one or more commercial content is pre-inserted in the email content in response to receiving the notification. In another embodiment, the one or more commercial content is added adjacent to the email content in the window. The one or more commercial content is then displayed to the user.

### FIELD OF THE INVENTION

The invention relates generally to an automated process of insertion of content and specifically, to method and system for displaying one or more commercial content within a window displaying an email content.

### BACKGROUND OF THE INVENTION

Rising popularity of Internet has led to it becoming a favorable medium for advertising. Typically, service providers provide advertisers with a platform to advertise online. Existing technologies allow a service provider to collect vast amounts of data from users based on various techniques such as determining the user's IP address, setting cookies on the user's computing device etc. The service provider can then display the most relevant commercial content to a user based on the collected information.

Many service providers provide free software or services to users by displaying the commercial content alongside an email or browser or any other application on the user's computing device. However, existing technology allows the commercial content to be inserted outside the main content, for instance, in a separate window or in case of an email, only in web based email services. Users who use Internet Message Access Protocol (“IMAP”) or Post Office Protocol (“POP3”) based email clients, generally download their emails within a local client computing device and read them within email clients such as Outlook, Outlook Express, Thunderbird etc. Therefore free email service providers or providers of chat services such as various instant messengers or even browsers could not insert commercial content in an unobtrusive manner within the email client.

Some of the current methods involve showing the email in a web browser and displaying commercial content alongside the email, in a separate frame or table, without modifying the contents of the original email or in a separate window. Hence there is a need to display commercial content within the body of the original content in such a manner that the commercial content is unobtrusive and can be removed when needed.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various, principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a flow diagram of a method for displaying one or more commercial content to a user within a window displaying an email content, in accordance with an embodiment of the present invention.

FIG. 2 illustrates a flow diagram of a method for retrieving the one or more commercial content, in accordance with an embodiment of the present invention.

FIG. 3 illustrates a block diagram of a system for displaying one or more commercial content to a user within a window displaying an email content, in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to displaying one or more commercial content to a user within a window displaying an email content. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of displaying one or more commercial content to a user within a window displaying an email content described herein. The non-processor circuits may include, but are not limited to, a radio receiver, a radio transmitter, signal drivers, clock circuits, power source circuits, and user input devices. As such, these functions may be interpreted as steps of a method and system for displaying one or more commercial content to a user within a window displaying an email content. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to displaying commercial content in an unobtrusive fashion within an email content such that the user's functionality is not compromised. Those skilled in the art shall appreciate that the commercial content can be any content that can either have a commercial value such as advertising content, or content that may lead a user to purchase a product or service or even content that can merely be informational in nature such as the weather of a city or stock quotes for the day or restaurants in places the user intends to visit or any such information. The email content can be any content within the body of an email, where the email can be a composed email, a reply to an email, a forwarded email, etc. Further, those skilled in the art shall also appreciate that the present invention is not only restricted to email systems and may extend to webpages, chat programs and any other application that may enable the display of the commercial content. For instance, an internet service provider may display commercial content such as advertisements, weather metadata information, stock quotes etc. to a user browsing webpages using a browser. Alternatively, a chat client may use a similar plugin disclosed above to display commercial content to users of the chat client. Hence, the scope of the present invention may extend to any and all applications on the user's computing device, which can display the commercial content.

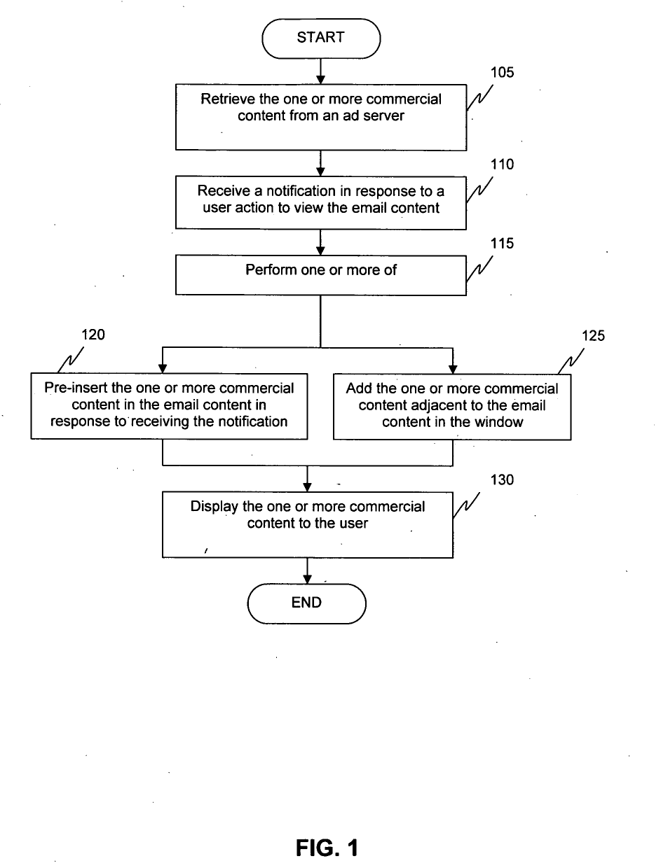

Turning now to FIG. 1, a flow diagram of a method of displaying one or more commercial content to a user within a window displaying an email content is shown pursuant to an embodiment of the present invention. The email content can be content included in any email of any form, such as, but not limited to, IMAP, POP3 etc. The email can be configured on an email client such as, but not limited to, Microsoft outlook, Mozilla thunderbird etc. The email can also be a web-based email, such as, but not limited to gmail, yahoomail, etc., which can be accessed on a web browser. Further, the window can be, but is not limited to, a preview pane within the email client, a view pane adjacent to the main email window, a new pop-up window of the email client, a reply pane, a forward pane, a view pane, a view window, a reply window and forward window within the email client.

The one or more commercial content to be displayed within the email content is initially retrieved from an ad server at step 105. When the user performs a user action, such as selecting or clicking on an email, which indicates that the user wishes to view the email content, a notification is received at step 110. The notification can be received in several ways. For example, the notification can be received from an operating system of the computing device of the user. In an alternate embodiment, the email client itself can send the notification as to whether the user has initiated an action to preview the email in the view pane or chosen to double-click on the email and display the email in a separate window.

In accordance with the present invention, at step 115, one or more of two embodiments can be performed for inserting the one or more commercial content in the email content.

In one embodiment, the one or more commercial content is pre-inserted, at step 120, in the email content in response to the notification. Pre-inserting, here, refers to inserting the one or more commercial content after the email is retrieved from the email store and before the email is rendered on the window of the email client. However, the commercial content is not stored in the copy of the email that is saved on one or more of the email client and the email server. Thus, the one or more commercial content is inserted on the fly without retaining it in the stored copy of the email.

Alternately, in another embodiment, instead of pre-inserting the one or more commercial content within the email content, the one or more commercial content is added adjacent to the email content in the window at step 125. The one or more commercial content can be added to the same window displaying the email content, or can be added to a separate window adjacent to the window displaying the email content, or can be added to a separate view panel within the window displaying the email content.

In another embodiment, a handle can be obtained to an engine that renders the window for displaying the email content and the engine can be instructed to add the commercial content when rendering the email.

A modified window, which includes the email content and one or more commercial content, is, then, displayed to the user at step 130. The one or more commercial content is displayed to the user in an unobtrusive manner so that the user experience is not hindered. The user can view the email in different ways depending on the email client the user uses. For instance, the user may use an email client such as Microsoft Outlook which provides the user with the ability to view the email within a preview pane in the email client itself when the user selects the email. In such a case, the email client in typically divided into two parts where the list of emails are displayed in one part and on selecting a specific email, the email is displayed in the preview pane. Here, the commercial content can be displayed within the email content in the preview pane, or on a separate window, or on a separate view pane within the preview pane.

In an alternate embodiment, the user may also double click on the email which may cause the email to display in a separate window of the email client. In this embodiment, the commercial content can be displayed within the email content in the separate window, or on a new window, or on a separate view pane within the window displaying the email content. Those skilled in the art shall appreciate that different email clients may have different methods for allowing users to view emails and all such method are within the scope of the present invention.

The above embodiments provide for the commercial content to be displayed within the window of the email content each time the user views the email. However, to ensure an unobtrusive experience for the user, in an embodiment of the present invention, the commercial content is removed in response to a user action. The user action can be, but is not limited to, a request made by the user to remove the commercial content, the user wishing to reply, forward or print the email or the user wishing to perform any action that requires the user to obtain an untainted copy of the email (without the commercial content). Those skilled in the art will appreciate that this is possible since each of the embodiments described above inserts the commercial content within the window and not in the actual email content and hence the original copy of the email stays intact within the email store of the email client.

Various embodiments of the present invention can enable an email service provider to provide a free email service to the user. The email service provider can generate revenue by displaying commercial content within the emails.

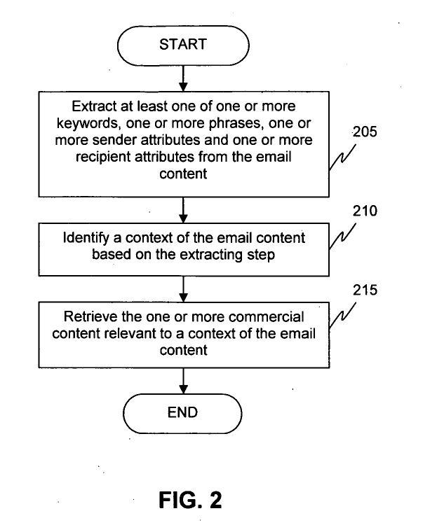

Turning now to FIG. 2, a flow diagram of a method for retrieving relevant commercial content is shown in accordance with an embodiment of the present invention. As mentioned in conjunction with FIG. 1, the commercial content is retrieved from the ad server at step 105. In an embodiment, commercial content that is relevant to a context of the email content to be displayed is retrieved.

For this purpose, one or more keywords, one or more phrases, one or more sender attributes and/or one or more recipient attributes are extracted from the email content, at step 205. The sender attributes can include an age of a sender, a location of the sender, a past behavior of the sender, and one or more pertinent metadata information about the sender. Similarly, the recipient attributes can include an age of the recipient, a location of the recipient, a past behavior of the recipient, and one or more pertinent metadata information about the recipient. Those skilled in the art will appreciate that the sender attributes and the recipient attributes can be derived from an email server and/or the email client. A context of the email content is then identified at step 210, based on step 205.

At step 215, the one or more commercial content relevant to the context identified at step 210 is retrieved. Thus, commercial content that is relevant to the user can be displayed to the user. This ensures that the commercial content is targeted which would, in turn, ensure a higher Return on Investment (ROI) for an advertiser advertising the commercial content.

For instance, the email content can include keywords and/or phrases that indicate that the email content is about cars. Thus, the context of the email can be identified as ‘Cars’. Further, the recipient attributes can indicate that the recipient is located in Washington, US. Thus, advertisements targeted at cars in Washington can be retrieved and displayed to the user.

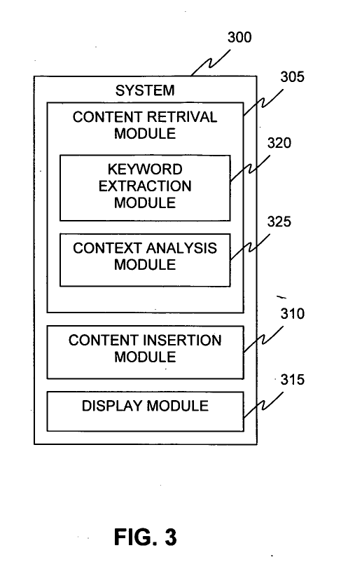

Turning now to FIG. 3, a block diagram of a system 300 for displaying one or more commercial content to a user within a window displaying an email content, in accordance with embodiment of the present invention. System 300 includes a content retrieval module 305, a content insertion module 310 and display module 315.

Content retrieval module 305 is configured to retrieve the one or more commercial content from an ad server. In an embodiment of the present invention, commercial content relevant to a context of the email content can be retrieved by content retrieval module 305. For this purpose, content retrieval module 305 can include a keyword extraction module 320 and a context analysis module 325. Keyword extraction module 320 is configured to extract one or more keywords, one or more phrases, one or more sender attributes and/or one or more recipient attributes from the email content. As mentioned in conjunction with FIG. 2, the sender attributes can include an age of a sender, a location of the sender, a past behavior of the sender, and one or more pertinent metadata information about the sender. Similarly, the recipient attributes can include an age of the recipient, a location of the recipient, a past behavior of the recipient, and one or more pertinent metadata information about the recipient. Those skilled in the art will appreciate that the sender attributes and the recipient attributes can be derived from an email server and/or the email client.

Context analysis module 325 then identifies a context of the email content based on the keywords, phrases etc. extracted by keyword extraction module 320. Those skilled in the art shall appreciate that the email can be received directly by the email client if context analysis module 325 resides at the email client or can be received by an external server, such as but not limited to, the senders mail server, the recipients mail server or an intermediary server through which the email passes, or is made to pass, if context analysis module 325 resides on the external server. Alternatively, context analysis module 325 may also reside on the senders computing device.

Content retrieval module 305 can then retrieve commercial content that is relevant to the context of the email content. This ensures that the commercial content is targeted towards the user.

When a user performs a user action, such as clicking or selecting an email, which indicates that the user wishes to view the email, a notification is received at content insertion module 310.

Content insertion module 310 can be notified of the user action in several ways. For example, in one embodiment where content insertion module 310 is not a part of the email client, content insertion module 310 is hooked into an operating system of the user and gets a notification from the operating system when the user initiates the user action. In an alternate embodiment where content insertion module 310 is a plugin or part of the email client, content insertion module 310 can be notified by the email client itself as to whether the user has initiated the user action to preview the email in a preview pane or chosen to double-click on the email and display the email in a separate window. As per another embodiment, content insertion module 310 can also hook into the preview pane, or the window displaying the email such that, whenever the preview pane is refreshed, or a new window pops up to display the email, content insertion module 310 is invoked to insert the commercial content within the email content.

Now, in one embodiment, in order to insert the commercial content within the window of the email content, content insertion module 310 is configured to pre-insert the commercial content in the email content. As mentioned earlier, pre-inserting refers to inserting the commercial content after the email is retrieved from the email store and before the email is rendered on the window of the email client. However, the commercial content may not be stored in a copy of the email that is saved on one or more of the email client and the email server. Thus, content insertion module 310 inserts the commercial content on the fly without retaining it in the stored copy of the email.

Alternately, in another embodiment, instead of pre-inserting the one or more commercial content within the email content, content insertion module 310 adds the one or more commercial content adjacent to the email content in the window. Content insertion module 310 can add the commercial content to the same window displaying the email content, or to a separate window adjacent to the window displaying the email content, or to a separate view panel within the window displaying the email content.

In another embodiment, content insertion module 310 can obtain a handle to an engine that renders the window for displaying the email content. Content insertion module 310 can instruct the engine to add the commercial content when rendering the email.

Those skilled in the art shall appreciate that the examples illustrated above are merely exemplary and any other methods can be used to insert the commercial content within the window or the preview pane of the email client in an unobtrusive manner and all such methods are within the scope of the present invention.

Display module 315 can then display a modified window, including the email and the commercial content, to the user. Display module 315 displays the commercial content to the user in an unobtrusive manner so that the user experience is not hindered. The user can view the email in different ways depending on the email client the user uses. For instance, the user may use an email client such as Microsoft Outlook which provides the user with the ability to view the email within a preview pane in the email client itself when the user selects the email. In such a case, the email client in typically divided into two parts where the list of emails are displayed in one part and on selecting a specific email, the email is displayed in the preview pane. Here, display module 315 can display the commercial content within the email content in the preview pane, or on a separate window, or on a separate view pane within the preview pane.

In an alternate embodiment, the user may also double click on the email which may cause the email to display in a separate window of the email client. In this embodiment, display module 315 displays the commercial content within the email content in the separate window, or on a new window, or on a separate view pane within the window displaying the email content. Those skilled in the art shall appreciate that different email clients may have different methods for allowing users to view emails and all such method are within the scope of the present invention.

In an embodiment of the present invention, to ensure an unobtrusive experience for the user, content insertion module 310 is configured to remove the commercial content in response to a user action. The user action can be, but is not limited to, a request made by the user to remove the commercial content, the user wishing to reply, forward or print the email or the user wishing to perform any action that requires the user to obtain an untainted copy of the email (without the commercial content). Those skilled in the art will appreciate that this is possible since content insertion module 310 inserts the commercial content within the window and not in the actual email content and hence the original copy of the email stays intact within the email store of the email client.

In one embodiment of the present invention, one or more system modules, including content retrieval module 305, content insertion module 310, display module 315, keyword extraction module 320 and context analysis module 325, reside on one or more of the email client, an operating system of a computing device of the user and a server. The email client can be a sender email client and/or a recipient email client. The server can be a sender email server, a recipient email server and/or an independent server.

In an embodiment of the present invention, the email client may include context analysis module 325 and content insertion module 310 installed as a plug-in from a third party performing the functions disclosed. The functionality can also be built into the email client instead. The third party can be an ad service or the email service provider providing the commercial content

In an alternate embodiment, context analysis module 325 can reside on a server and content insertion module 310 can be installed on the email client as a plug-in from the third party. The email client can be a sender email client and/or a recipient email client.

In yet another embodiment, one or more of the system modules can reside as programs on a sender computing device and/or a recipient computing device.

Those skilled in the art will realize that insertion of the commercial content can allow email service providers to generate revenue from the commercial content and, in turn, offer free email services to users.

In accordance with the present invention, the email service providers can display the commercial content in a web-based email client and/or desktop based email clients, such as, Outlook, Eudora, Outlook Express, Lotus Notes or any other email client using IMAP or POP3 protocols. The commercial content can be removed when a user wished to reply to the email, forward the email, print the email content etc. Further the commercial content is displayed in an unobtrusive manner so that the user experience is not hampered.

What is claimed is:

1. A method of displaying one or more commercial content to a user within a window displaying an email content, the method comprising:
retrieving the one or more commercial content from an ad server;
receiving a notification in response to a user action to view the email content;
displaying the one or more commercial content to the user, the displaying step comprising performing one of:
pre-inserting the one or more commercial content in the email content in response to receiving the notification; and
adding the one or more commercial content adjacent to the email content in the window.

2. The method of claim 1, wherein the one or more commercial content is relevant to a context of the email content, the retrieving step comprising:
extracting at least one of one or more keywords, one or more phrases, one or more sender attributes and one or more recipient attributes from the email content; and
identifying a context of the email content based on the extracting step.

3. The method of claim 2, wherein the one or more sender attributes comprise an age of a sender, a location of the sender, a past behavior of the sender, and one or more pertinent metadata information about the sender, and the one or more recipient attributes comprise an age of the recipient, a location of the recipient, a past behavior of the recipient, and one or more pertinent metadata information about the recipient, wherein the one or more sender attributes and the one or more recipient attributes are derived from one or more of an email server and an email client.

4. The method of claim 1, wherein the notification is received from one or more of:
an operating system of a computing device of the user; and
an email client.

5. The method of claim 1, wherein the window is one or more of a preview pane, a reply pane, a forward pane, a view pane, a view window, a reply window and forward window within an email client.

6. The method of claim 1, wherein the pre-inserting step comprises displaying a modified email content in the window, the modified email content comprising the email content and the one or more commercial content, wherein the one or more commercial content is absent in a stored copy of the email, wherein the stored copy of the email is stored in one or more of an email client and an email server.

7. The method of claim 1, wherein the email content comprises one or more of an email, a composed email, a reply to an email and a forward of an email.

8. The method of claim 1 further comprises removing the one or more commercial content in response to a user action.

9. The method of claim 8, wherein the user action comprises one or more of a request made by the user, printing the email, forwarding the email, replying to the email and modifying the email.

10. The method of claim 1, wherein the user is provided with a free email service, wherein revenue is generated by displaying the one or more commercial content within the email.

11. A system of displaying one or more commercial content to a user within a window displaying an email content, the system comprising:
a content retrieval module, the content retrieval module configured to retrieve the one or more commercial content from an ad server;
a content insertion module, the content insertion module configured to:
receive a notification in response to a user action to view the email content; and
perform one or more of:
pre-inserting the one or more commercial content in the email content in response to the content insertion module receiving the notification; and
adding the one or more commercial content adjacent to the email content in the window;
a display module, the display module configured to display the one or more commercial content to the user.

12. The system of claim 11, wherein the content retrieval module retrieves the one or more commercial content relevant to a context of the email content, the content retrieval module comprising:
a keyword extraction module, the keyword extraction module configured to extract at least one of one or more keywords, one or more phrases, one or more sender attributes and one or more recipient attributes from the email content; and
a context analysis module, the context analysis module configured to identify a context of the email content.

13. The system of claim 11, wherein the notification is received from one or more of:
an operating system of a computing device of the user; and
an email client.

14. The system of claim 11, wherein when the content insertion module pre-inserts the one or more commercial content, the display module displays a modified email content in the window, the modified email content comprising the email content and the one or more commercial content, wherein the one or more commercial content is absent in a stored copy of the email, wherein the stored copy of the email is stored in one or more of an email client and an email server.

15. The system of claim 11, wherein the content insertion module is further configured to remove the one or more commercial content from the email content in response to a user action.

16. The system of claim 12, wherein one or more system modules reside on one or more of an email client, an operating system of a computing device of the user and a server, the email client being one of a sender email client and a recipient email client and the server being one or more of a sender email server, a recipient email server, and an independent server, the system modules comprising the content retrieval module, the content insertion module, the display module, the keyword extraction module and the context analysis module.

17. The system of claim 12, wherein the context analysis module and the content insertion module are installed in an email client as a plug-in from a third party, the one or more commercial content being provided by the third party to the user, the email client being one of a sender email client and a recipient email client.

18. The system of claim 12, wherein the context analysis module resides on a server and the content insertion module is installed on an email client as a plug-in from a third party, the one or more commercial content being provided by the third party to the user, the email client being one of a sender email client and a recipient email client.

19. The system of claim 12, wherein one or more system modules reside as programs on one or more of a sender computing device and a recipient computing device, the system modules comprising the content retrieval module, the content insertion module, the display module, the keyword extraction module and the context analysis module.
